(19) United States
(12) Patent Application Publication
(10) Pub. No.: US 2026/0128708 A1
(43) Pub. Date: May 7, 2026

(54) DEVICES, METHODS, AND SYSTEMS FOR INSTALLATION OF PHOTOVOLTAIC SYSTEMS

(71) Applicant: PV SOLUTIONS, LLC, Park City, UT (US)

(72) Inventor: Joseph TOMLINSON, Park City, UT (US)

(21) Appl. No.: 19/232,501

(22) Filed: Jun. 9, 2025

Related U.S. Application Data
(63) Continuation of application No. 18/932,040, filed on Oct. 30, 2024.
Application No. 18/932,040 is a continuation of application No. 18/089,181, filed on Dec. 27, 2022, now abandoned.
Application No. 18/089,181 is a continuation of application No. 17/288,229, now abandoned.
(60) Provisional application No. 62/749,648, filed on Oct. 23, 2018.

(51) Int. Cl. H02S 20/23; F24S 25/60; F24S 25/63; F24S 25/70; H01R 4/64; H02S 30/00

(52) U.S. Cl. CPC H02S 20/23; H01R 4/64; H02S 30/00; F24S 2025/6005; F24S 25/63; F24S 25/70; Y02B 10/10; Y02E 10/50

(57) ABSTRACT

Devices, methods, and systems for installing photovoltaic systems are provided that are simple and easy to install, and that minimize the number of separate components or parts needed. Such devices, methods, and systems ensure seamless mechanical and electrical connectivity by their design, and minimize the time and effort expended by tradespersons or other technicians, especially in dangerous environments.

### CROSS-REFERENCE TO RELATED APPLICATIONS

This application is a continuation of U.S. patent application Ser. No. 18/932,040, filed Oct. 30, 2024, which is a continuation of U.S. patent application Ser. No. 18/089,181, filed Dec. 27, 2022, which is a continuation of U.S. patent application Ser. No. 17/288,229, filed Apr. 23, 2021, which is a national stage application under 35 U.S.C. § 371 and claims the benefit of PCT Application No. PCT/US2019/057685 having an international filing date of 23 Oct. 2019, which designated the United States, and which PCT application claims the benefit of priority under 35 U.S.C. § 119(e) to U.S. Provisional Patent Application 62/749,648, filed 23 Oct. 2018. The entireties of each of the above-referenced applications are incorporated herein by reference.

### FIELD OF THE INVENTION

This invention relates generally to devices, methods, and systems for installing photovoltaic systems, and specifically to photovoltaic installation systems that reduce the cost and time associated with photovoltaic installation.

### BACKGROUND OF THE INVENTION

Current devices, methods, and systems for installing photovoltaic systems, especially residential photovoltaic systems, suffer from several drawbacks. Such devices, methods, and systems are often complex and difficult to install, and may require the use of many separate components or parts. These devices, methods, and systems typically also require a tradesperson or other technician to expend significant time and effort ensuring that the photovoltaic system is properly installed and that the system's mechanical and electrical connections to other components are secure; as a result, the tradesperson or other technician may need to move frequently for an extended period of time, often in a dangerous environment (e.g. on top of a roof).

There is thus a need in the art for devices, methods, and systems for installing photovoltaic systems that are simple and easy to install, and that minimize the number of separate components or parts needed. It is further advantageous for such devices, methods, and systems to ensure seamless mechanical and electrical connectivity by their design, and to minimize the time and effort expended by tradespersons or other technicians, especially in dangerous environments.

### SUMMARY OF THE INVENTION

It is one aspect of the present invention to provide a system for securing an energy capturing/storage device to a surface, comprising a rail, affixed to the surface and comprising a groove disposed on at least one face; and a shuttle, comprising a fastener, securely seated within the groove of the rail; at least one intermediate component, comprising a means for electrically interconnecting the energy capturing/storage device to the rail or a component disposed therein, and securely interconnected to the fastener; and a device attachment, securely holding the energy capturing/storage device in place, securely interconnected to at least one intermediate component, and comprising a lever or other means allowing a user to selectively detach the energy capturing/storage device from the system.

In embodiments, the at least one intermediate component may comprise a first intermediate component and a second intermediate component, wherein the first intermediate component is securely interconnected to the fastener and the second intermediate component is securely interconnected to the device attachment, and wherein the first and second intermediate components may be selectively detached from each other. The shuttle may comprise a void extending from a surface of the shuttle into an interior of the shuttle, and the system may further comprise a key adapted to be selectively disposed within the void to selectively prevent movement of at least one of the fastener, an intermediate component, and the device attachment relative to at least one of the rail, the fastener, at least one intermediate component, and the device attachment.

In embodiments, the fastener may be securely interconnected to at least one intermediate component along two or more sides or surfaces of the fastener.

In embodiments, the rail may comprise means for electrically interconnecting two or more energy capturing/storage devices associated with the rail.

In embodiments, the shuttle may be adapted to slide within the groove of the rail in and/or along at least one of a length, a width, and a height of the rail to be selectively positioned at a desired position of the rail. The system may comprise at least two shuttles, wherein the at least two shuttles may be selectively configured to slide within the groove of the rail together and/or as a single unit.

In embodiments, the energy capturing/storage device may be a photovoltaic solar panel.

In embodiments, the surface may be a roof.

It is another aspect of the present invention to provide a shuttle for securing an energy capturing/storage device to a surface, comprising a fastener, adapted to be securely seated within a groove disposed on a face of a rail; at least one intermediate component, comprising a means for electrically interconnecting the energy capturing/storage device to the rail or a component disposed therein, and securely interconnected to the fastener; and a device attachment, securely holding the energy capturing/storage device in place, securely interconnected to at least one intermediate component, and comprising a lever or other means allowing a user to selectively detach the energy capturing/storage device from the shuttle.

In embodiments, the at least one intermediate component may comprise a first intermediate component and a second intermediate component, wherein the first intermediate component is securely interconnected to the fastener and the second intermediate component is securely interconnected to the device attachment, and wherein the first and second intermediate components may be selectively detached from each other. The shuttle may further comprise a void, extending from a surface of the shuttle into an interior of the shuttle; and a key, adapted to be selectively disposed within the void to selectively prevent movement of at least one of the fastener, an intermediate component, and the device attachment relative to at least one of the rail, the fastener, at least one intermediate component, and the device attachment.

In embodiments, the fastener may be securely interconnected to at least one intermediate component along two or more sides or surfaces of the fastener.

In embodiments, the shuttle may be adapted to slide within the groove of the rail in and/or along at least one of a length, a width, and a height of the rail to be selectively positioned at a desired position of the rail. The shuttle may be selectively reconfigurable to allow the shuttle to slide within the groove of the rail together and/or as a single unit with a separate shuttle.

In embodiments, the energy capturing/storage device may be a photovoltaic solar panel.

In embodiments, the surface may be a roof.

It is another aspect of the present invention to provide a method for positioning and securing a solar panel on a surface, comprising (a) interconnecting the solar panel to a shuttle, wherein the shuttle is securely interconnected to a groove in a rail affixed to the surface and positioned at or near one end of the rail; (b) sliding the shuttle within the groove to a desired position on the rail; and (c) fixing the shuttle in place at the desired position on the rail.

In embodiments, step (c) may comprise placing the shuttle in association with an element that physically blocks and/or prevents further movement of the shuttle along the rail.

In embodiments, step (c) may comprise activating an element that selectively locks the shuttle and/or presses the shuttle in place against the rail at the desired position.

In embodiments, the surface may be a roof.

It is another aspect of the present invention to provide an apparatus for positioning and securing a solar panel on a surface, adapted and/or configured to receive a solar panel, interconnect the solar panel to a shuttle that is securely interconnected to a groove in a rail affixed to the surface, slide the shuttle within the groove to a desired position on the rail, and fix the shuttle in place at the desired position on the rail.

In embodiments, the apparatus may be adapted and/or configured to fix the shuttle in place by placing the shuttle in association with an element that physically blocks and/or prevents further movement of the shuttle along the rail.

In embodiments, the apparatus may be adapted and/or configured to fix the shuttle in place by activating an element that selectively locks the shuttle and/or presses the shuttle in place against the rail at the desired position.

In embodiments, the surface may be a roof.

In embodiments, the apparatus may be adapted and/or configured to receive a cartridge comprising a plurality of solar panels and separate each solar panel from the cartridge before interconnecting each solar panel to a separate shuttle.

### BRIEF DESCRIPTION OF THE DRAWINGS

FIG. 1 is an exploded view of a shuttle and rail of a first embodiment of the present invention, illustrating various component parts of the shuttle.

FIG. 2 is a view of a prototype shuttle of the first embodiment of the present invention.

FIG. 3 is an exploded view of a shuttle and rail of a second embodiment of the present invention, illustrating various component parts of the shuttle.

FIG. 4 is an unexploded view of the shuttle and rail illustrated in FIG. 3.

FIG. 5 is a comparison view of the shuttles and rails of the first and second embodiments of the present invention.

FIG. 6 is a view of the shuttle fixed in place on the rail, according to the second embodiment of the present invention.

FIG. 7 is an end view of the shuttle and rail of the second embodiment of the present invention, illustrating the connection between the rail and the shuttle.

FIGS. 8A and 8B are illustrations of a key associated with the shuttle of the second embodiment of the present invention in an unlocked and locked state, respectively.

FIG. 9 is an illustration of the locking mechanism between the key and the other components of the shuttle of the second embodiment of the present invention.

FIG. 10 is an illustration of a photovoltaic solar cell affixed to two shuttles according to the second embodiment of the present invention.

FIG. 11 is an illustration of multiple rails and shuttles, according to the second embodiment of the present invention, interconnected to each other and affixed to a roof.

FIGS. 12A and 12B are two alternative shuttle/rail configurations for affixing a plurality of solar panels to a roof or other surface, according to embodiments of the present invention.

FIGS. 13A through 13H are illustrations of a method of installing solar panels on a roof, according to embodiments of the present invention.

FIG. 14 is an illustration of a shuttle/rail configuration for affixing a plurality of solar panels to a roof or other surface, according to embodiments of the present invention.

FIG. 15 is an illustration of a module clip of a device attachment of a shuttle, according to embodiments of the present invention.

FIG. 16 is an illustration of a device clip seated within a device attachment of a shuttle, according to embodiments of the present invention.

FIG. 17 is an illustration of a device attachment of a shuttle, according to embodiments of the present invention.

FIG. 18 is an illustration of a frame of a photovoltaic device, according to embodiments of the present invention.

FIG. 19 is an illustration of a shuttle within a rail, according to embodiments of the present invention.

FIG. 20 is an illustration of an intermediate component of a shuttle, according to embodiments of the present invention.

FIG. 21 is an illustration of a fastener element of a shuttle, according to embodiments of the present invention.

FIG. 22 is an illustration of a top plate of a shuttle, according to embodiments of the present invention.

FIG. 23 is an exploded view of a shuttle, according to embodiments of the present invention.

FIG. 24 is an isometric cutaway view of a shuttle, according to embodiments of the present invention.

FIG. 25 is an isometric view of a shuttle having a shuttle cover, according to embodiments of the present invention.

FIG. 26 is an elevation view of a shuttle having a shuttle cover, according to embodiments of the present invention.

FIG. 27 is a plan view of a shuttle having a shuttle cover, according to embodiments of the present invention.

FIG. 28 is a plan view of a shuttle having a shuttle cover and end covers, according to embodiments of the present invention.

FIG. 29 is an isometric view of a shuttle, according to embodiments of the present invention.

FIG. 30 is an elevation view of a shuttle, according to embodiments of the present invention.

FIG. 31 is a plan view of a shuttle, according to embodiments of the present invention.

### DETAILED DESCRIPTION OF THE INVENTION

For purposes of further disclosure and to comply with applicable written description and enablement requirements, the following references generally relate to devices, methods, and systems for mounting photovoltaic solar panels, and are hereby incorporated by reference in their entireties:
U.S. Pat. No. 6,360,491, entitled “Roof support system for a solar panel,” issued 26 Mar. 2002 to Ullman (“Ullman”).
U.S. Pat. No. 6,799,743, entitled “Bracket for mounting auxiliary machinery to vehicle body,” issued 5 Oct. 2004 to Sawayanagi (“Sawayanagi”).
U.S. Pat. No. 7,226,107, entitled “Method and apparatus for sunvisor attachment,” issued 5 Jun. 2007 to Wheeler et al. (“Wheeler”).
U.S. Pat. No. 7,406,800, entitled “Mounting system for a solar panel,” issued 5 Aug. 2008 to Cinnamon (“Cinnamon”).
U.S. Pat. No. 8,826,618, entitled “Roof mount assembly,” issued 9 Sep. 2014 to Stearns (“Stearns”).
U.S. Pat. No. 8,984,818, entitled “Snap-in mounting systems for laminate solar panels,” issued 24 Mar. 2015 to McPheeters et al. (“McPheeters”).
U.S. Pat. No. 9,136,792, entitled “Mounting system for photovoltaic arrays,” issued 15 Sep. 2015 to Tomlinson (“Tomlinson I”).
U.S. Pat. No. 9,142,967, entitled “System for tracking and allocating renewable energy contributions to a modular renewable energy system,” issued 22 Sep. 2015 to Tomlinson (“Tomlinson II”).
U.S. Patent Application Publication 2016/0006252, entitled “System for tracking and allocating renewable energy contributions to a modular renewable energy system,” published 7 Jan. 2016 to Tomlinson (“Tomlinson III”).
U.S. Pat. No. 9,899,955, entitled “Integrated electrical and mechanical photovoltaic array interconnection system,” issued 20 Feb. 2018 to Tomlinson (“Tomlinson IV”).
U.S. Pat. No. 10,008,974, entitled “Mounting system for photovoltaic arrays,” issued 26 Jun. 2018 to Tomlinson (“Tomlinson V”).

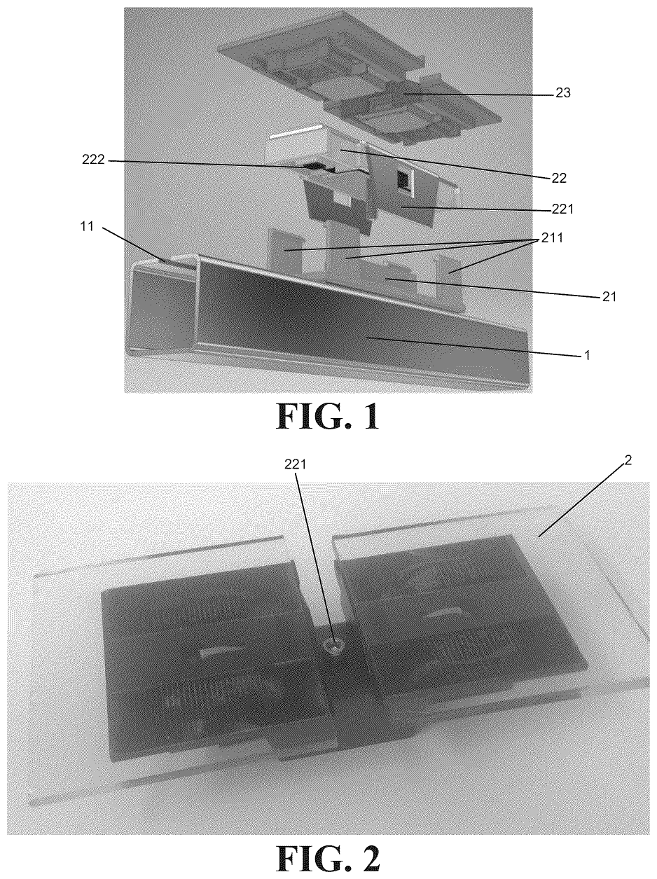

Referring now to FIG. 1, a shuttle and rail according to a first embodiment of the present invention are illustrated. In this embodiment, the rail 1, which is generally adapted to be affixed to a surface such as a roof, comprises a groove, slot, or other similar feature 11 in at least one face, in this case a top face. Securely interconnected to, e.g. at least partially disposed within, the groove 11 of the rail 1 is a shuttle 2 for receiving a photovoltaic solar panel or other energy capturing/storage device. The shuttle, illustrated in exploded form in FIG. 1, comprises a bottom fastener element 21, an intermediate component 22, and a device attachment 23. The fastener 21 is securely interconnected to, e.g. at least partially disposed within, the groove 11 of the rail 1, and comprises a plurality of vertical flanges or posts 211 to receive and secure the intermediate component 22. The intermediate component 22 comprises a means 221 for securely interconnecting the shuttle 2 to the rail 1; in the embodiment illustrated in FIG. 1, such means 221 comprises two vertical “wings” that are adapted to extend downwardly beyond the fastener 21 and overlap the outer edges of the rail 1, as well as a central aperture through which a screw or similar device projects. The screw may interface with a threaded aperture or similar feature of the fastener. The intermediate component 22 also includes a means 222, in this case a wire, by which the energy capturing/storage device may electrically interconnect with, e.g., the rail 1, other energy capturing/storage devices secured to the rail 1, and/or an extrinsic electrical system such as the electrical system of a home. Overlying the intermediate component 22 is the device attachment 23, which securely interconnects the energy capturing/storage device to the shuttle 2 by any suitable means. The device attachment 23 may comprise a lever or similar element (not illustrated) enabling a user to selectively detach the energy/capturing storage device from the shuttle. Among many other advantages, the system illustrated in FIG. 1 greatly reduces the need for junction boxes, additional cables, and other equipment necessary for the functioning of other solar panel mounting systems.

Referring now to FIG. 2, a prototype of a shuttle 2 of the first embodiment of the present invention is illustrated. The “wings” and central aperture of the interconnecting means 221 of the intermediate component 22 are clearly visible.

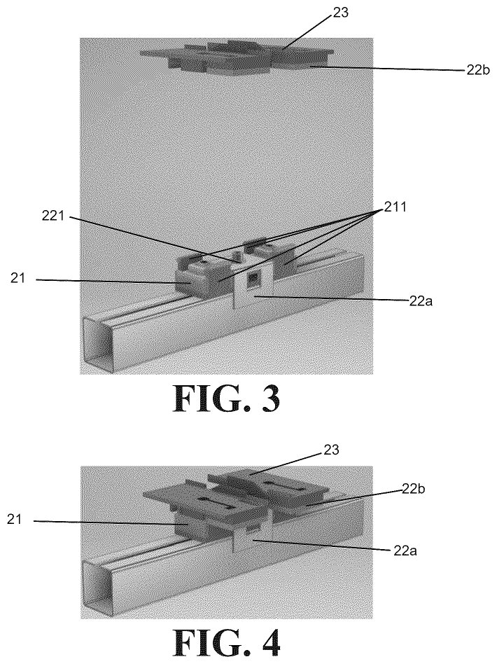

Referring now to FIG. 3, a shuttle and rail according to a second embodiment of the present invention is illustrated. As illustrated in FIG. 3, a first intermediate component 22a is seated within the volume defined by the flanges/posts 211 of the fastener element 21 and is securely interconnected to the rail by both the “wings” and the central screw of the interconnecting means 221, while a second intermediate component 22b is illustrated in association with the device attachment 23. The second intermediate component 22b and device attachment 23 may then be disposed atop the first intermediate component 22a and the fastener 21, to provide for secure interconnection of the energy capturing/storage device to the rail, as illustrated in FIG. 4.

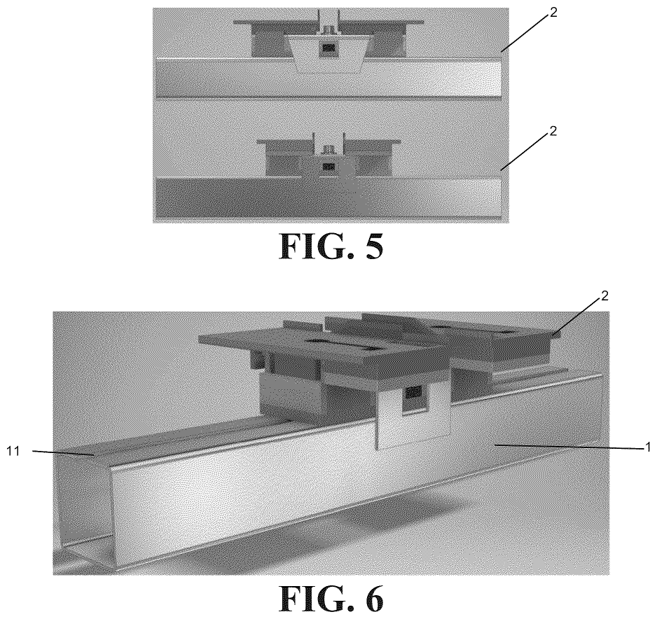

Referring now to FIG. 5, an end view of the first and second embodiments of the shuttle 2 is illustrated to allow comparison between the embodiments. As can be seen from FIG. 5, the footprint of the second embodiment of the shuttle is smaller than a footprint of the first embodiment of the shuttle, which may enable a material savings of up to 25% in constructing the second embodiment of the shuttle relative to the first embodiment of the shuttle.

Referring now to FIG. 6, the second embodiment of the shuttle 2 is illustrated as securely interconnected with the rail 1. Note that the shuttle 2 may be configured to slide within the groove 11 along a length of the rail 1, enabling simple and easy repositioning of the shuttle 2 (and, thus, the associated energy capturing/storage device).

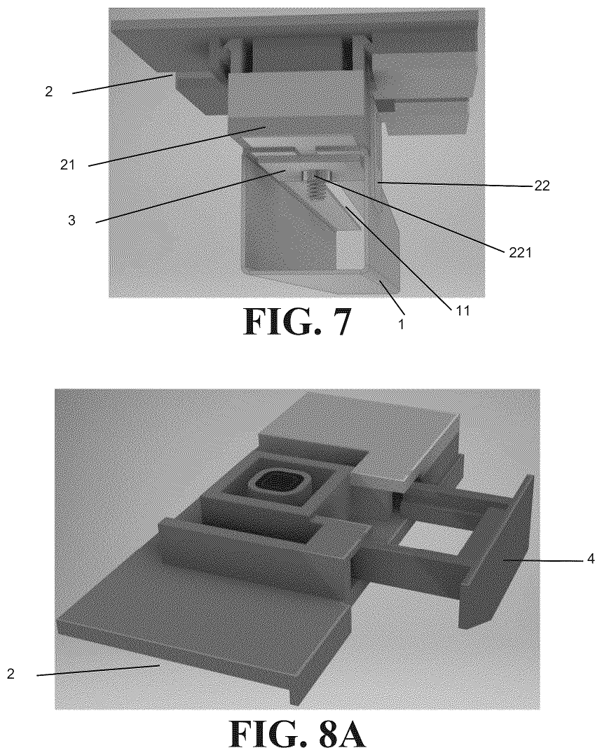

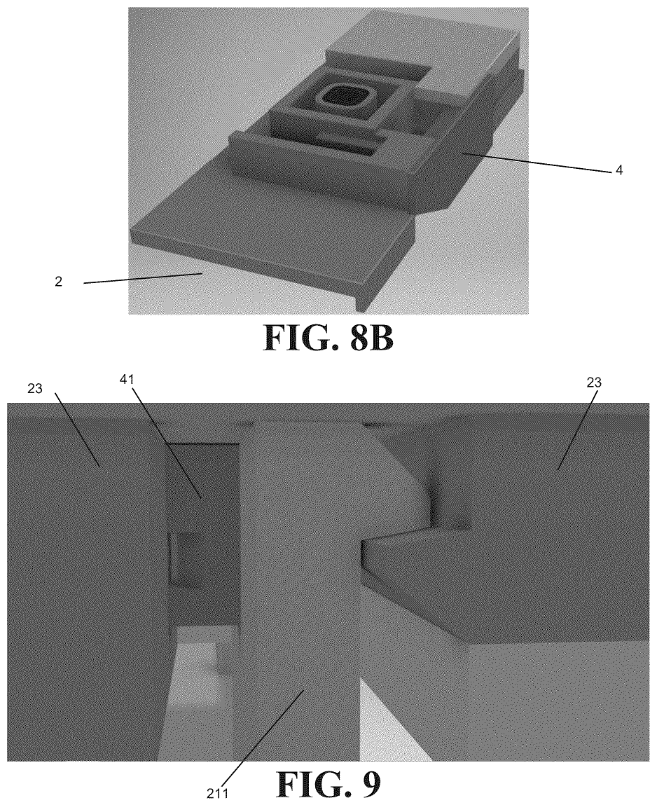

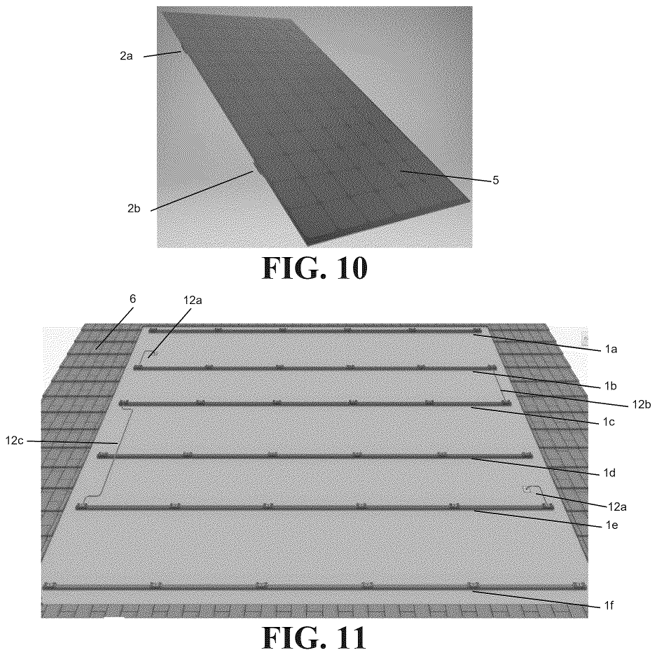

Referring now to FIG. 7, an end view of the shuttle and rail of the second embodiment of the present invention is illustrated. As can be seen from FIG. 7, the shuttle 2 is securely interconnected to the rail by means of both the “wings” of the intermediate component 22 and the screw through the central aperture of the interconnecting means 221. In this embodiment, the screw not only holds the intermediate component 22 and the fastener element 21 flush against each other, but also extends through the fastener element 21 and the groove 11 in the rail 1 to tightly hold the shuttle 2 against a plate 3 disposed on the underside of the groove 11. This provides additional stability for the shuttle 2 as it slides along the groove 11 of the rail 1, but because the plate 3 does not contact the outer faces of the rail 1, the movement of the shuttle 2 along the rail 1 is not impeded. Thus, the shuttle 2 may be smoothly and easily repositioned along the rail 1.

Referring now to FIGS. 8A and 8B, the second embodiment of the shuttle 2 is shown in association with a “key” or other locking device 4. The key 4 is configured to snugly fit with a void in the shuttle 2, to selectively prevent movement of one or more components of the shuttle 2 relative to one or more other components of the shuttle 2 and/or the rail 1. In FIG. 8A, the key 4 is shown in an “unlocked,” or partially removed, position, while in FIG. 8B the key 4 is shown in a locked, or fully inserted, position. One advantage of the key 4 is that a user may easily and selectively insert or remove the key 4 to prevent or enable movement and/or disassembly of the shuttle 2.

Referring now to FIG. 9, a close-up view of the interface between the key 4 and various other elements of the shuttle 2 is illustrated. As illustrated in FIG. 9, a prong 41 of the key 4 fits in the void between corresponding surfaces of the device attachment 23 and the fastener 21 and presses the flange/post 211 of the fastener 21 into a snug fit with a corresponding element of the device attachment 23. In this way, the key 4 ensures that all elements of the shuttle 2 fit tightly and will not separate or become detached during, e.g., movement of the shuttle 2 along the rail 1.

Referring now to FIG. 10, a photovoltaic solar panel 5 is illustrated as interconnected to at least two shuttles 2a, 2b according to the second embodiment of the present invention. The secure interconnection of the two shuttles 2a, 2b to one or more rails (not shown) affixed to a surface (not shown) allows the photovoltaic solar panel 5 to be simply and easily positioned or repositioned at a desired location of the rail and/or surface by simply sliding the shuttles 2a, 2b along the groove in the rail(s). In this way, a tradesperson or other technician can interconnect the solar panel 5 to the shuttle(s) 2 and then simply push the shuttle(s) 2 along the rail(s) to a desired location; by this method, the need for the tradesperson or other technician to physically reposition himself/herself is minimized or even eliminated, and the panel(s) 5 can be positioned with a minimum of time and effort. Referring now to FIG. 11, six rails 1a, 1b, 1c, 1d, 1e, 1f according to the present invention are illustrated as affixed to a surface 6, in this case the roof of a home. Of the six rails, three (the second and third from the top 1b, 1c and the second from the bottom 1e) provide an electrical interconnection to each other and/or to electrical systems within the home, while the other three (the first from the top 1a and the third and first from the bottom 1d, 1f) merely provide additional structural support for photovoltaic solar panels or other energy capturing/storage devices that may be placed in association with the rails 1. As illustrated, the second rail from the top 1b and the second rail from the bottom 1e each have a wired electrical connection 12a running downwardly through the roof 6 into the home (at the left end of the second rail from the top 1b and the right end of the second rail from the bottom 1e). The second and third rails 1b, 1c from the top are also electrically interconnected by a wired connection 12b at the rails' right ends, and the third rail from the top 1c is electrically interconnected to the second rail from the bottom 1e (bypassing the third rail from the top 1d) by still another wired connection 12c at the rails' left ends. As may be appreciated, one or more of the rails 1 may also contain a connection to a hot and/or cold water system of the home that may enable interconnection with thermal panels on the roof, alone or in addition to photovoltaic solar panels; in this way, a “roof radiator” that may improve the energy efficiency of the home may be provided. Other advantageous energy capturing/storage devices, and means and systems for incorporating such devices into a home, may be contemplated.

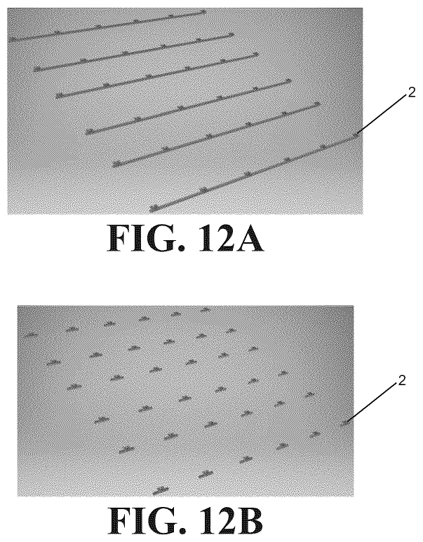

Referring now to FIGS. 12A and 12B, two alternative shuttle/rail configurations for securing a plurality of energy capturing/storage devices to a roof or other surface, according to embodiments of the present invention, are illustrated. In FIG. 12A, six rails each extend across a substantial portion of the surface to which the energy capturing/storage devices are to be affixed. In FIG. 12B, an alternative embodiment is depicted, whereby each shuttle is provided in association with only a short portion of rail that does not communicate with the rails associated with any other shuttles. The embodiment illustrated in FIG. 12B may be desirable in certain applications, e.g. where the surface is large and/or where the weight-bearing capacity of the surface is a consideration and repositioning of the energy capturing/storage devices is unlikely to be necessary.

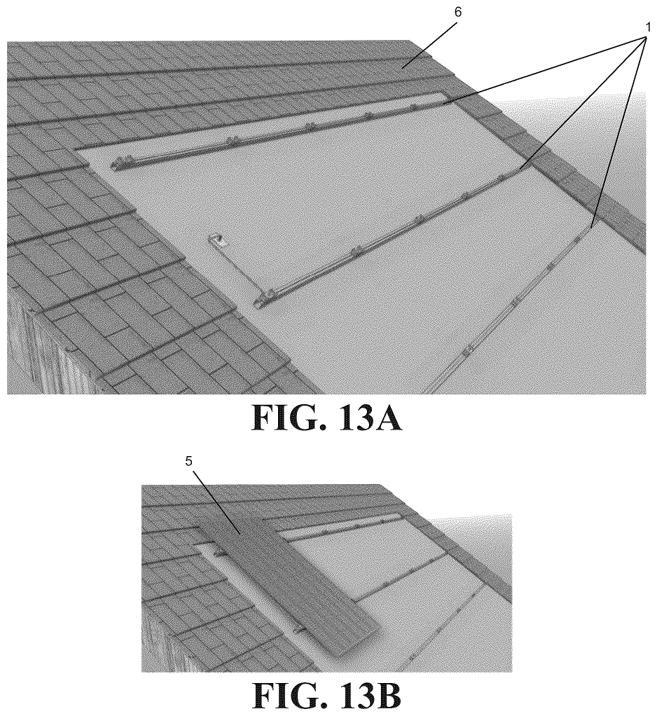

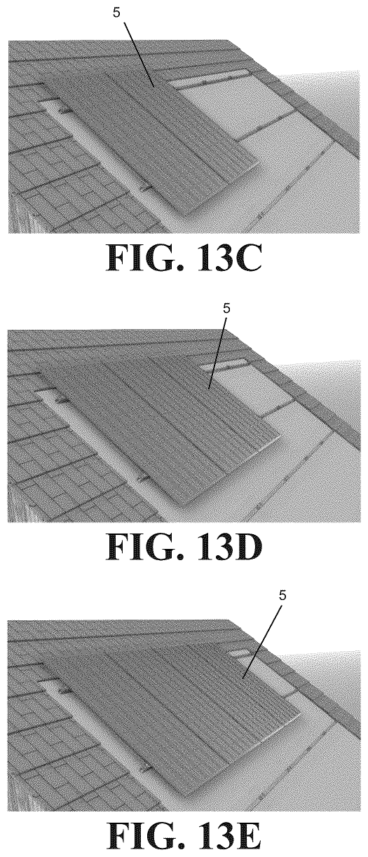

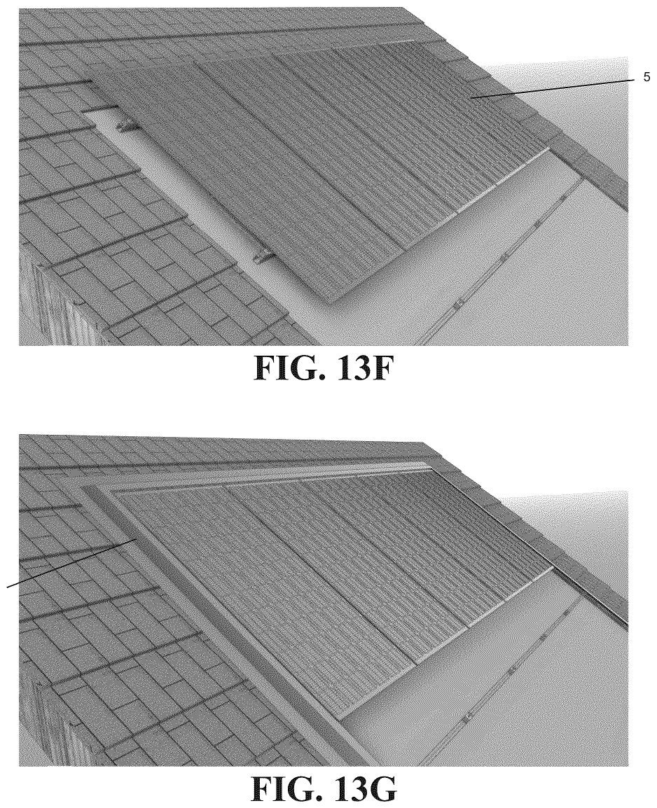

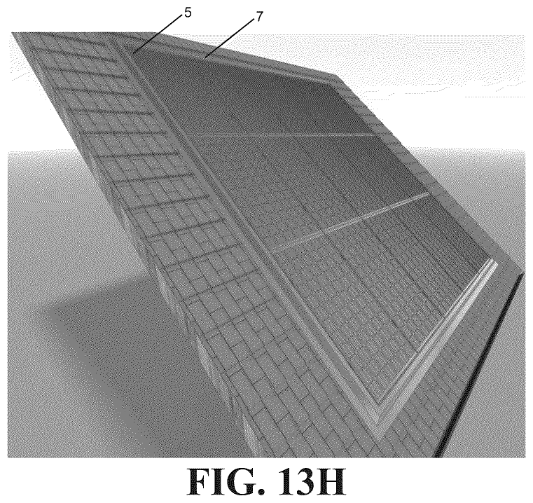

Referring now to FIGS. 13A through 13H, a method for securing a plurality of photovoltaic solar panels 5 to a roof 6 is illustrated. As an initial matter, a plurality of rails 1 is affixed to the roof 6, as illustrated in FIG. 13A. Then, as illustrated in FIGS. 13B through 13F, solar panels 5 may be affixed to, e.g., each of two adjacent rails 1 by interconnecting the panels 5, one at a time, to shuttles 2 associated with one or both rails 1. It is to be expressly understood that the shuttles 2 may be fixed in place, whereby a tradesperson or other technician moves along the roof 6 to install each panel 5, or the shuttles 2 may be permitted to slide along the rail(s) 1, whereby the tradesperson or other technician may remain at one end of the rail(s) 1 and push and/or slide the shuttle(s) 2 to a desired position of the rail(s) 1 after securing each panel 5 to the shuttle(s) 2. As illustrated in FIG. 13G, flashing 7 may be installed around the panels 5 and/or rails 1 to improve the aesthetics of the solar panel system and limit the exposure of the rails 1 and shuttles 2 to animals, debris, and other hazards; the flashing 7 may also conceal a thermal water panel or other system associated with and underlying the solar panel system, if present. FIG. 13H illustrates a fully constructed solar panel system, whereby three rows of solar panels 5 have been secured to three pairs of rails 1 and surrounded by flashing 7 according to methods of the present invention.

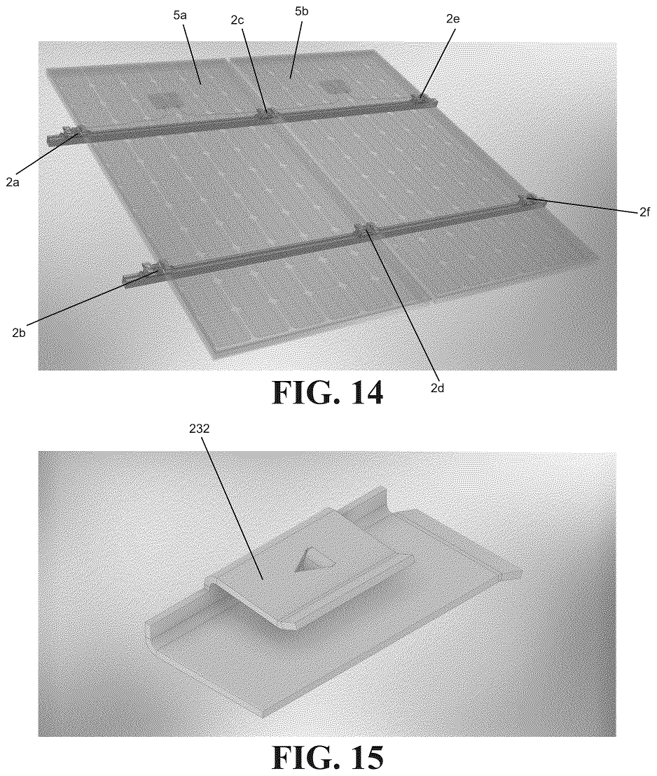

Referring now to FIG. 14, two photovoltaic panels 5a, 5b are shown affixed to six shuttles 2a, 2b, 2c, 2d, 2e, 2f. As illustrated, each of the photovoltaic panels 5a, 5b, is affixed, at or near each corner of the photovoltaic panel 5, to four shuttles 2; specifically, photovoltaic panel 5a is affixed to shuttles 2a, 2b, 2c, and 2d, and photovoltaic panel 5b is affixed to shuttles 2c, 2d, 2e, and 2f, or, in other words, at least shuttles 2c and 2d are configured to receive and affix a portion of both photovoltaic panels 5a, 5b. Although not illustrated in FIG. 14, any number of shuttles may be configured to receive two or more photovoltaic panels, such that any number of photovoltaic panels may be secured to a surface such as a roof using a minimum of shuttles; in embodiments, the total number of shuttles may be no more than about 2N+2, where N is the number of photovoltaic panels (i.e. a first photovoltaic panel 5a requires four shuttles, and each subsequent photovoltaic panel 5b, 5c, . . . requires only two additional shuttles).

FIG. 14 further illustrates one possible configuration of electrical connections of the photovoltaic panels 5a, 5b to each other and/or to another electrical system, in this case the electrical system of a home to the roof of which the photovoltaic panels 5a, 5b are secured. As illustrated, a serial electrical connection is completed between the photovoltaic panels 5a, 5b by an electrical connector housed within one or more shuttles 2. In addition, a cable from a junction box is plugged into an electrical connector housed within the device attachment 23 of at least one shuttle 2 associated with a photovoltaic panel 5, which in turn is electrically connected to the adjacent photovoltaic panel 5. In this way, a shuttle 2c, 2d that is configured to receive two or more photovoltaic panels 5 may thus connect the two photovoltaic panels 5 both mechanically and electrically.

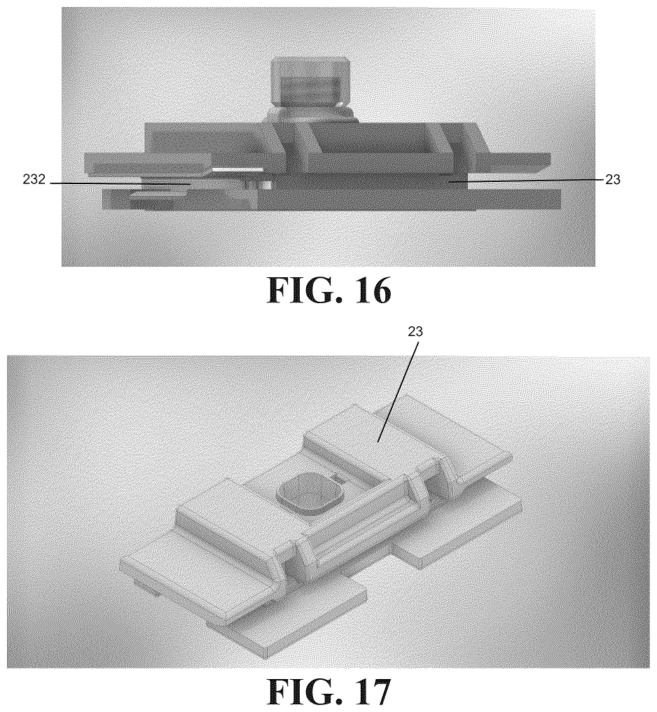

Referring now to FIG. 15, a module clip 232 that forms part of one embodiment of a device attachment 23 is illustrated. As illustrated, the module clip 232 is or has a sharp “tooth,” which is configured to be seated within the device attachment 23 prior to attachment of a photovoltaic panel 5. The module clip 232 is configured to “grab” or “bite,” i.e. securely hold in place, a portion of a frame of the photovoltaic panel 5; typically, this occurs where the device attachment 23 is configured to be secured to the photovoltaic panel 5 by being pressed or “snapped” into place. Thus, when a user, such as a tradesperson or other technician, presses the device attachment 23 into or onto a corresponding portion of the frame of the photovoltaic panel 5 (or vice versa), the module clip 232, by securely holding the photovoltaic panel 5 in place, ensures that the device attachment 23 does not slide out of position relative to the photovoltaic panel 5, other components of the shuttle 2, or the rail 1. Referring now to FIG. 16, a side view of the module clip 232 seated within the device attachment 23 is illustrated. The module clip may be installed via an opening in any face, in this case a lateral face, of the device attachment 23. In embodiments, the module clip 232 may be selectively removable from a remainder of the device attachment 23. The fully assembled device attachment 23, shown in a perspective view rather than a side view is illustrated in FIG. 17.

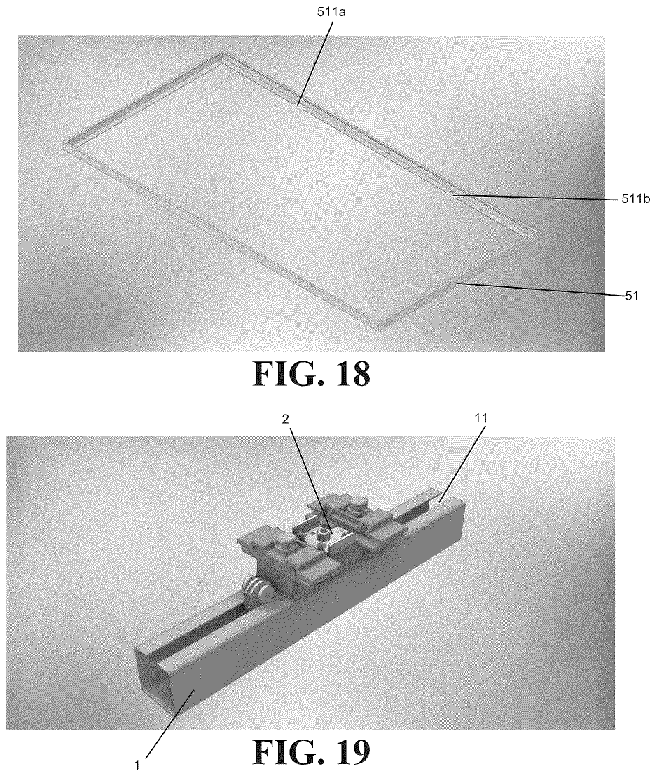

Referring now to FIG. 18, an embodiment of a frame 51 of a photovoltaic panel 5 for use in the methods and systems of the present invention is illustrated. In this embodiment, the frame 51 comprises rectangular notches 511a, b that receive and/or are received by device attachments 23 of respective shuttles. As discussed throughout this disclosure, the notches 511 and the device attachments 23 may be securely interconnected by any suitable means; particularly, in some embodiments, the device attachments 23 may be seated in, e.g. by being pressed or “snapped” into, the notches 511, and/or the notches 511 may be “grabbed” or “bitten” by module clips 232.

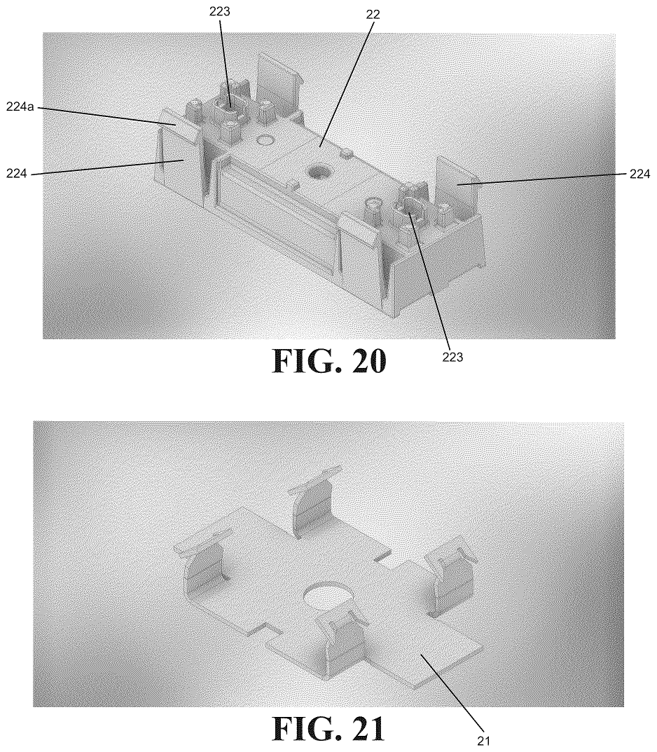

Referring now to FIG. 19, a completely assembled shuttle 2 is shown seated within a groove 11 of a rail 1. The shuttle 2 of this embodiment may, but need not, be configured to attach to, e.g., a notch 511 in a frame 51 of a photovoltaic panel 5, as illustrated in FIG. 18. Referring now to FIG. 20, one embodiment of an intermediate component 22 is illustrated in further detail. In this embodiment, the intermediate component 22 comprises openings 223 in either end of the intermediate component 22 that allow for an electrical connector 222 housed within the intermediate component 22 to be interconnected to other electrical components of the electrical system. Disposed on either side of the openings 223 are fingers, flanges, or posts 224, each of which comprises a hook 224a; the hooks 224a are configured to snap into and snugly fit within corresponding portions of the device attachment 23 during assembly of the shuttle 2.

Referring now to FIG. 21, one embodiment of a fastener element 21 is illustrated in further detail. In this embodiment, the fastener element 21 takes the form of a bonding clip that securely interconnects the various components of the shuttle 2 to each other and to the underlying rail 1.

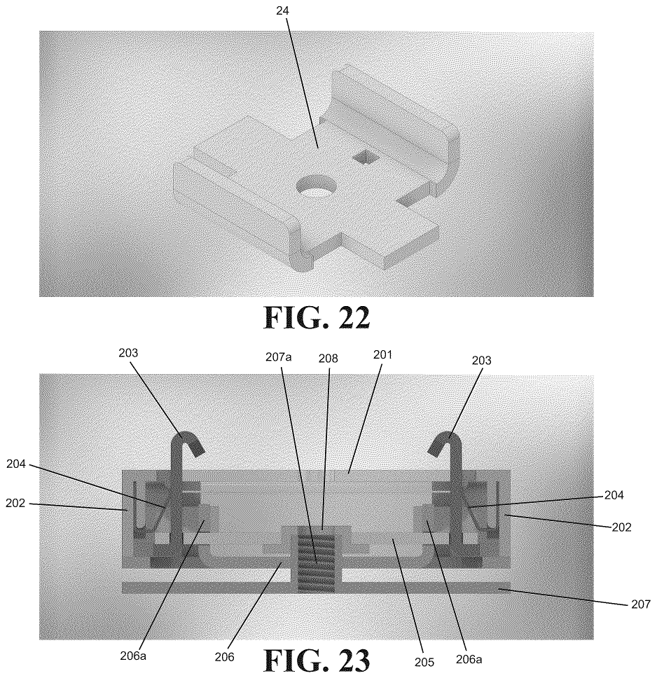

Referring now to FIG. 22, a shuttle 2 may optionally comprise a top plate 24. The top plate 24 is generally constructed of a resilient material such as steel, and may be mounted to the top of the shuttle 2. The top plate 24 may assist in establishing the proper position of the various components of the shuttle 2 during assembly, and may also provide a “bridge” between two or more photovoltaic panels 5 to distribute forces between the panels 5 during installation. In this way, the top plate 24 may relieve the device attachment 23 of lateral forces between two or more photovoltaic panels 5 during installation, as well as lateral forces between components of the shuttle 2 that may occur during thermal and load cycling and any other lateral forces that may be introduced during the life of, e.g., a rooftop photovoltaic system.

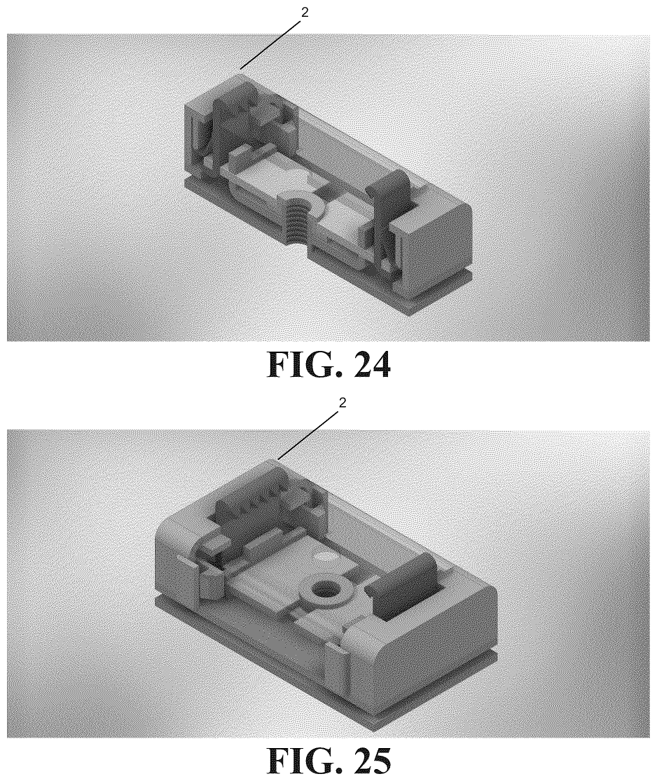

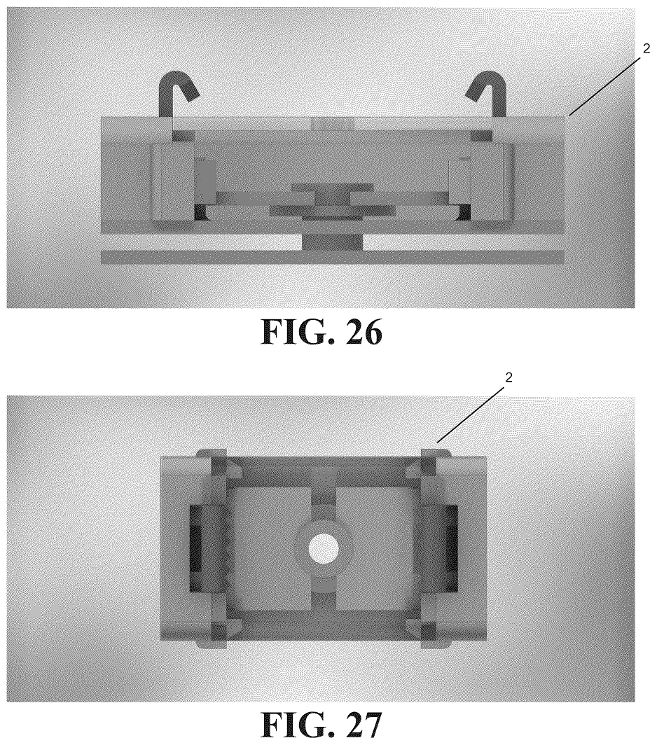

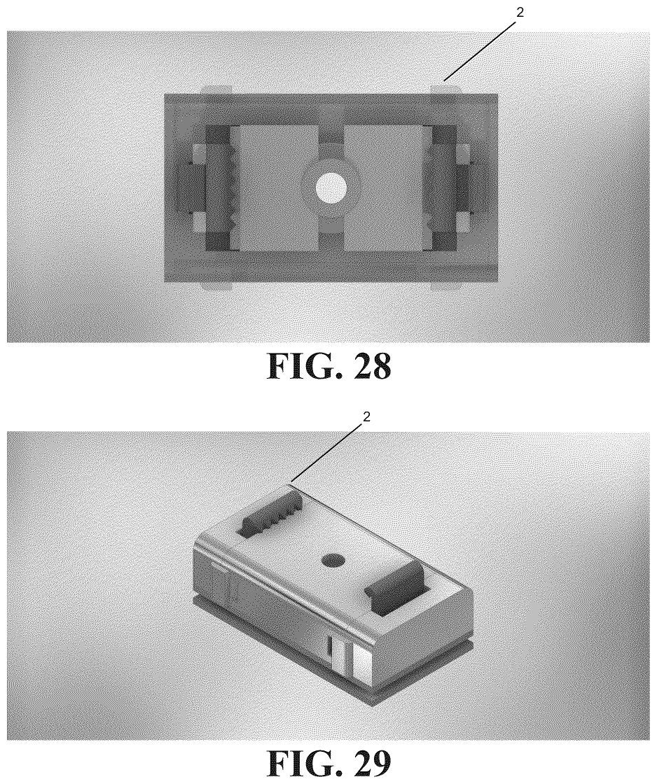

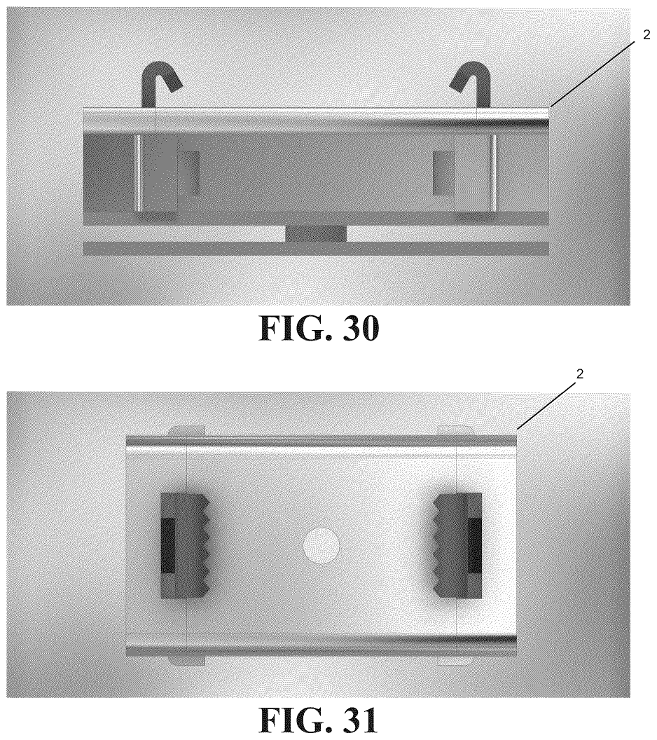

Referring now to FIGS. 23-31, another embodiment of a shuttle 2 according to the present invention is illustrated. The embodiment of the shuttle illustrated in FIGS. 23-31 comprises a shuttle cover 201, one or more shuttle end covers 202, at least one hanger clip 203 with an associated hanger clip spring 204, at least one lever arm 205, a base plate 206 having at least one flange 206a, a bottom plate 207 having a threaded tube 207a, and a bottom plate washer cap 208 atop the threaded tube 207a. The embodiment of the shuttle illustrated in FIGS. 23-31 utilizes a lever arm compression system, wherein the shuttle 2 is “loose,” i.e. the various components of the shuttle 2 are (at least initially, prior to interconnection with a photovoltaic panel 5) not snugly interconnected to each other and the hanger clips 203 are free to spring open and shut within a slot punched into the frame 51 of the photovoltaic panel 5. This embodiment of the shuttle 2 is provided with a top plate (not shown), similar to the top plate 24 of the shuttle illustrated in FIG. 22, which establishes the proper position of the photovoltaic panel 5 and the shuttle 2 relative to each other during assembly. When the shuttle 2 illustrated in FIGS. 23-31 is positioned in the appropriate position along a rail (not shown), the bottom plate 207 is drawn upward. As the bottom plate 207 is drawn upward, a force is applied to the lever arm(s) 205 by the upward movement of the bottom plate washer cap 208, which in turn pulls the bottom of the hanger clip(s) 203 downward with roughly equal force, thereby drawing the teeth of the hanger clip(s) 203 downward into the frame 51 of the photovoltaic panel 5. In this way, the action of the lever arm(s) 205 simultaneously securely interconnects the various components of the shuttle 2 together and secures the photovoltaic panel 5 to the shuttle 2, by dint of the teeth of the hanger clip(s) 203 “grabbing” or “biting” a corresponding portion of the frame 51 of the photovoltaic panel 5. Thus, the embodiment of the shuttle 2 illustrated in FIGS. 23-31 does not require a device attachment 23.

It should be noted that, although not illustrated in FIGS. 23-31, this embodiment of the shuttle 2 may further comprise an electrical connector disposed on one end of the shuttle 2 that aligns with an electrical connector positioned on the frame 51 of the photovoltaic panel 5. Particularly, one end cover 202 may comprise a blind electrical connector that passes through to an opposing end of the shuttle 2 to accept a serial connection of an adjacent photovoltaic panel 5 as the photovoltaic panels 5 are mechanically installed.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments to streamline the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A system for securing an energy capturing/storage device to a surface, comprising:
a rail, affixed to the surface and comprising a groove disposed on at least one face; and
a shuttle, comprising:
a fastener, securely seated within the groove of the rail;
at least one intermediate component, comprising a means for electrically interconnecting the energy capturing/storage device to the rail or a component disposed therein, and securely interconnected to the fastener; and
a device attachment, securely holding the energy capturing/storage device in place, securely interconnected to at least one intermediate component, and comprising a lever or other means allowing a user to selectively detach the energy capturing/storage device from the system.

2. The system of claim 1, wherein the at least one intermediate component comprises a first intermediate component and a second intermediate component, wherein the first intermediate component is securely interconnected to the fastener and the second intermediate component is securely interconnected to the device attachment, and wherein the first and second intermediate components may be selectively detached from each other.

3. The system of claim 2, wherein the shuttle comprises a void extending from a surface of the shuttle into an interior of the shuttle, and wherein the system further comprises a key adapted to be selectively disposed within the void to selectively prevent movement of at least one of the fastener, an intermediate component, and the device attachment relative to at least one of the rail, the fastener, at least one intermediate component, and the device attachment.

4. The system of claim 1, wherein the fastener is securely interconnected to at least one intermediate component along two or more sides or surfaces of the fastener.

5. The system of claim 1, wherein the rail comprises means for electrically interconnecting two or more energy capturing/storage devices associated with the rail.

6. The system of claim 1, wherein the shuttle may slide within the groove of the rail in and/or along at least one of a length, a width, and a height of the rail to be selectively positioned at a desired position of the rail.

7. The system of claim 6, comprising at least two shuttles, wherein the at least two shuttles may be selectively configured to slide within the groove of the rail together and/or as a single unit.

8. The system of claim 1, wherein the energy capturing/storage device is a photovoltaic solar panel.

9. The system of claim 1, wherein the surface is a roof.

10. A shuttle for securing an energy capturing/storage device to a surface, comprising:
a fastener, adapted to be securely seated within a groove disposed on a face of a rail;
at least one intermediate component, comprising a means for electrically interconnecting the energy capturing/storage device to the rail or a component disposed therein, and securely interconnected to the fastener; and
a device attachment, securely holding the energy capturing/storage device in place, securely interconnected to at least one intermediate component, and comprising a lever or other means allowing a user to selectively detach the energy capturing/storage device from the shuttle.

11. The shuttle of claim 10, wherein the at least one intermediate component comprises a first intermediate component and a second intermediate component, wherein the first intermediate component is securely interconnected to the fastener and the second intermediate component is securely interconnected to the device attachment, and wherein the first and second intermediate components may be selectively detached from each other.

12. The shuttle of claim 11, further comprising:
a void, extending from a surface of the shuttle into an interior of the shuttle; and
a key, adapted to be selectively disposed within the void to selectively prevent movement of at least one of the fastener, an intermediate component, and the device attachment relative to at least one of the rail, the fastener, at least one intermediate component, and the device attachment.

13. The shuttle of claim 10, wherein the fastener is securely interconnected to at least one intermediate component along two or more sides or surfaces of the fastener.

14. The shuttle of claim 10, wherein the shuttle is adapted to slide within the groove of the rail in and/or along at least one of a length, a width, and a height of the rail to be selectively positioned at a desired position of the rail.

15. The shuttle of claim 14, wherein the shuttle is selectively reconfigurable to allow the shuttle to slide within the groove of the rail together and/or as a single unit with a separate shuttle.

16. The shuttle of claim 10, wherein the energy capturing/storage device is a photovoltaic solar panel.

17. The shuttle of claim 10, wherein the surface is a roof.

18. A method for positioning and securing a solar panel on a surface, comprising:
(a) interconnecting the solar panel to a shuttle, wherein the shuttle is securely interconnected to a groove in a rail affixed to the surface and positioned at or near one end of the rail;
(b) sliding the shuttle within the groove to a desired position on the rail; and
(c) fixing the shuttle in place at the desired position on the rail.

19. The method of claim 18, wherein step (c) comprises placing the shuttle in association with an element that physically blocks and/or prevents further movement of the shuttle along the rail.

20. The method of claim 18, wherein step (c) comprises activating an element that selectively locks the shuttle and/or presses the shuttle in place against the rail at the desired position.

21. The method of claim 18, wherein the surface is a roof.

22. An apparatus for positioning and securing a solar panel on a surface, adapted and/or configured to receive a solar panel, interconnect the solar panel to a shuttle that is securely interconnected to a groove in a rail affixed to the surface, slide the shuttle within the groove to a desired position on the rail, and fix the shuttle in place at the desired position on the rail.

23. The apparatus of claim 22, wherein the apparatus is adapted and/or configured to fix the shuttle in place by placing the shuttle in association with an element that physically blocks and/or prevents further movement of the shuttle along the rail.

24. The apparatus of claim 22, wherein the apparatus is adapted and/or configured to fix the shuttle in place by activating an element that selectively locks the shuttle and/or presses the shuttle in place against the rail at the desired position.

25. The apparatus of claim 22, wherein the surface is a roof.

26. The apparatus of claim 22, wherein the apparatus is adapted and/or configured to receive a cartridge comprising a plurality of solar panels and separate each solar panel from the cartridge before interconnecting each solar panel to a separate shuttle.
